(19) United States
(12) Patent Application Publication
(10) Pub. No.: US 2023/0385061 A1
(43) Pub. Date: Nov. 30, 2023

(54) COMPUTING ACCELERATOR, DATA PROCESSOR AND ASSOCIATED METHOD

(71) Applicant: ALIBABA (CHINA) CO., LTD., ZHEJIANG PROVINCE (CN)

(72) Inventors: XUANLE REN, SHANGHAI (CN); YANHENG LU, SHANGHAI (CN); JIANSONG ZHANG, BEIJING (CN); ZHAOHUI CHEN, BEIJING (CN)

(21) Appl. No.: 18/322,416

(22) Filed: May 23, 2023

(30) Foreign Application Priority Data
May 31, 2022 (CN) 202210608385.4

(51) Int. Cl. G06F 9/30; G06F 9/38; H04L 9/00

(52) U.S. Cl. CPC G06F 9/30036; G06F 9/3877; H04L 9/008

(57) ABSTRACT

The present application discloses a computing accelerator, a data processor and an associated method for homomorphic encryption. The computing accelerator is configured to perform computations on input polynomials to generate output polynomials. The input polynomials are ciphertexts generated from a plaintext data after ring learning with error encryption, and the output polynomials correspond to a result after performing a linear computation on the plaintext data. The computing accelerator includes a polynomial multiplying unit, a coefficient extraction unit, and ciphertext wrapping unit. The polynomial multiplication unit multiplies a first input polynomial with a second input polynomial to generate an intermediate polynomial. The coefficient extraction unit converts the intermediate polynomial into a target polynomial according to a target coefficient in the intermediate polynomial. The ciphertext wrapping unit generates an output polynomial according to at least the target polynomial.

### CROSS-REFERENCE TO RELATED APPLICATIONS

This application claims priority of China application No. 202210608385.4, filed on May 31, 2022, which is incorporated by reference in its entirety.

### TECHNICAL FIELD

The present application relates to a computing accelerator, and more particularly, to a computing accelerator capable of accelerating the linear computation of homomorphic encryption.

### BACKGROUND

Since artificial intelligence (AI) models, such as neural network models, can analyze huge amounts of data and extract meaningful information from it, they can be useful for many kinds of industries. However, AI models often require large amounts of expensive computing hardware resources that not every company or research institute can afford; therefore, in order to allow more industries to benefit from the data analysis capabilities of AI, some server providers have started to provide remote computing services. In other words, users can upload the data they want to calculate or analyze to the cloud, and the server providers can provide the service of computing data remotely, and then eventually transmit the calculation results back to the users.

However, the data provided by the user may be confidential and therefore such a service may have security issues. Homomorphic encryption has been introduced to improve the security of data during such services. The homomorphic encryption allows the provider of computing services to perform a specific form of algebraic operation on the encrypted ciphertext, and the encrypted data obtained from the algebraic operation, when decrypted, may be the same as the result of the same algebraic operation on the plaintext data. In other words, the computing service provider can directly use the ciphertext to perform a specific form of computation, such as linear computation, without knowing the contents of the plaintext data, thus improving the security of the service. However, the format of the ciphertext generated by homomorphic encryption often has a more complex format, which requires more time or hardware resources for the computing service provider to complete the computation. Therefore, how to improve the computational performance of homomorphic encryption has become an urgent issue in the related field.

### SUMMARY

One embodiment of the present disclosure discloses a computing accelerator. The computing accelerator is configured to perform computations on a plurality of input polynomials of homomorphic encryption to generate output polynomials, wherein the plurality of input polynomials are ciphertexts generated from a plaintext data after ring learning with error (RLWE) encryption, and the output polynomials correspond to results after performing a linear computation on the plaintext data. The computing accelerator includes a polynomial multiplication unit, a coefficient extraction unit and a ciphertext wrapping unit. The polynomial multiplication unit is configured to multiply a first input polynomial and a second input polynomial in the plurality of input polynomials to generate a first intermediate polynomial, wherein the first input polynomial corresponds to a plurality of first plaintext values in the plaintext data, the second input polynomial corresponds to a plurality of second plaintext values in the plaintext data, and the first intermediate polynomial is a ciphertext encrypted using RLWE. The coefficient extraction unit is configured to convert the first intermediate polynomial into a first target polynomial of a learning with errors (LWE) ciphertext according to a first target coefficient in a plurality of coefficients of the first intermediate polynomial, wherein the first target coefficient corresponds to a result of performing the linear computation on the plurality of first plaintext values and the plurality of second plaintext values. The ciphertext wrapping unit is configured to generate the output polynomial according to at least the first target polynomial, wherein the output polynomial is a ciphertext encrypted usingRLWE.

A further embodiment of the present disclosure provides a data processor. The data processor is configured to convert a plaintext data as a plurality of input polynomials of homomorphic encryption and transmit the plurality of input polynomials to a remote computing accelerator so that the computing accelerator performs a linear computation required by the plaintext data. The data processor includes an encoding unit and an encryption unit. The encoding unit is configured to encode a plurality of values in the plaintext data into a plurality of plaintext input polynomials according to a type of the linear computation. The encryption unit is configured to encrypt the plurality of plaintext input polynomials to generate the plurality of input polynomials according to RLWE.

A further embodiment of the present disclosure provides a method for performing computations on a plurality of input polynomials of homomorphic encryption to achieve a linear computation of a plaintext data. The method includes: using a computing accelerator to receive the plurality of input polynomials, wherein the plurality of input polynomials are ciphertexts generated from a plaintext data after RLWE encryption; using the computing accelerator to multiply a first input polynomial and a second input polynomial of the plurality of input polynomials to generate a first intermediate polynomial, wherein the first input polynomial corresponds to a plurality of first plaintext values in the plaintext data, the second input polynomial corresponds to a plurality of second plaintext values in the plaintext data, and the first intermediate polynomial is a ciphertext encrypted using RLWE; using the computing accelerator to convert the first intermediate polynomial into a first target polynomial according to a target coefficient in a plurality of coefficients of the first intermediate polynomial, wherein the first target coefficient corresponds to a result after performing the linear computation on the plurality of first plaintext values and the plurality of second plaintext values, and the first target polynomial is a ciphertext encrypted using learning with errors (LWE); using the computing accelerator to generate the output polynomial according to at least the first target polynomial, wherein the output polynomial is a ciphertext encrypted using RLWE; and using the computing accelerator to output the output polynomial to a data processor.

The data processor, computing accelerator and calculation method of homomorphic encryption provided in the embodiments of the present application can encode values in plaintext data into polynomials based on the type of linear computation, so that after performing homomorphic encryption on the polynomials, the computing accelerator only needs to multiply the corresponding polynomials to generate intermediate polynomials so as to obtain the ciphertext corresponding to the calculation results of the plaintext data in the coefficients of the specific terms of the intermediate polynomials, thereby reducing the computational complexity required for the computing accelerator and achieving the efficacy of accelerated computation.

### BRIEF DESCRIPTION OF THE DRAWINGS

FIG. 1 is a schematic diagram illustrating a homomorphic encryption calculation system according to one embodiment of the present disclosure.

FIG. 2 is a flowchart of a calculation method of homomorphic encryption according to one embodiment of the present disclosure.

FIG. 3 is a schematic diagram illustrating an embodiment of the computing accelerator of FIG. 1.

FIG. 4 is a schematic diagram illustrating an embodiment of the polynomial multiplication unit of FIG. 3.

FIG. 5 is a schematic diagram illustrating an embodiment of the ciphertext wrapping unit of FIG. 3.

### DETAILED DESCRIPTION

The following disclosure provides various different embodiments or examples for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various embodiments. This repetition is for the purpose of simplicity and clarity and does not in itself dictate a relationship between the various embodiments and/or configurations discussed.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “generally” means within an acceptable standard error of the mean when considered by one of ordinary skill in the art. As could be appreciated, other than in the operating/working examples, or unless otherwise expressly specified, all of the numerical ranges, amounts, values, and percentages (such as those for quantities of materials, duration of times, temperatures, operating conditions, portions of amounts, and the likes) disclosed herein should be understood as modified in all instances by the term “generally.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Here, ranges can be expressed herein as from one endpoint to another endpoint or between two endpoints. All ranges disclosed herein are inclusive of the endpoints, unless specified otherwise.

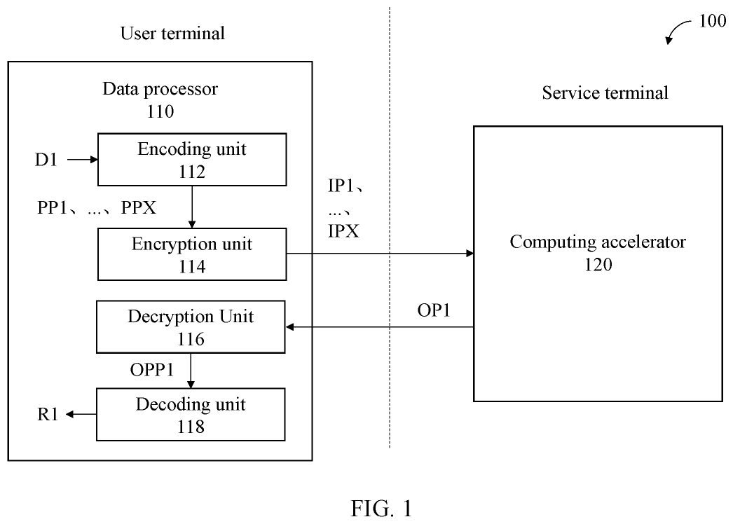

FIG. 1 is a schematic diagram illustrating a homomorphic encryption calculation system 100 according to one embodiment of the present disclosure. The homomorphic encryption calculation system 100 includes a data processor 110 and a computing accelerator 120. In the present embodiment, the data processor 110 can encrypt the plaintext data D1 to be computed as ciphertexts using the technology of homomorphic encryption, and the computing accelerator 120 can calculate the received ciphertexts and transmit the ciphertext of the calculation result to the data processor 110. In such case, the data processor 110 would obtain the calculation result of the plaintext data D1 after decrypting the ciphertexts of the calculation result.

In the present embodiment, the computing accelerator 120 can be disposed at a server terminal or a service terminal configured to provide computation services, whereas the data processor 110 can be disposed at a data provider terminal or a user terminal that can use the computation services. In other words, the data processor 110 can use the computing accelerator 120 at a remote server terminal to perform linear computation of the plaintext data D1, thereby reducing the hardware requirements for the user terminal where the data processor 110 locates.

In the embodiments of the present disclosure, the homomorphic encryption calculation system 10 can use the ring learning with errors (RLWE) technique to perform homomorphic encryption. Since the RLWE encryption uses polynomials as the format of input data, the data processor 110 can first encode the plaintext data D1 to be computed into polynomials of the plaintext, and then encrypt the plaintext polynomials to generate ciphertext polynomials of RLWE.

As shown in FIG. 1, the data processor 110 can include an encoding unit 112 and an encryption unit 114. The encoding unit 112 can encode a plutality of values in the plaintext data D1 into a plurality of plaintext input polynomials PP1 to PPX, and the encryption unit 114 can encrypt the plaintext input polynomials PP1 to PPX according to RLWE to generate a plurality of input polynomials IP1 to IPX, wherein X is an integer greater than 1. Correspondingly, the computing accelerator 120 can receive the ciphertext input polynomials IP1 to IPX generated by the data processor 110 and perform calculation on the input polynomials IP1 to IPX.

Since RLWE can only ensure that the result of ciphertext after linear computation will remain homomorphic, but not after other forms of computations, the computing accelerator 120 is generally used to perform linear computations on the ciphertext as required in neural network-like or artificial intelligence models, such as but not limited to vector dot product, matrix multiplication, and convolution. Since the calculations of these linear computations and polynomial multiplications are mainly dot product calculations, if the data processor 110 can encode the values in the plaintext data D1 into polynomials in an appropriate order during the encoding stage, the computing accelerator 120 can multiply the corresponding values by polynomial multiplication, so as to quickly complete the linear computation of the plaintext data D1, and in such case, it can effectively reduce the the computational burden of data processor 110.

For example, the data processor 110 can encode the vectors v [p₀, p₁, p₂, p₃, p₄] in the plaintext data D1 into a polynomial P (x) according to an encoding order and can encode the vectors u [q₀, q₁, q₂, q₃, q₄] in the plaintext data D1 into a polynomial Q (x) according to an inverse encoding order, as shown in Equation (1) and Equation (2).

P(x)=p₀+p₁x+p₂x²+p₃x³+p₄x⁴ Equation (1)

Q(x)=q₄+q₃x+q₂x²+q₁x³+q₀x⁴ Equation (2)

In such case, the result, polynomial R (x), of multiplying the polynomial P (x) with the polynomial Q (x) can be shown as Equation (3).

R(x)=P(x)·Q(x)=(p₀q₄)+(p₁q₄+p₀q₃)x+(p₂q₄+p₁q₃+p₀q₂)x²++(p₃q₄+p₂q₃+p₁q₂+p₀q₁)x³+(p₄q₄+p₃q₃+p₂q₂+p₁q₁+p₀q₀)x⁴+. . . +p₄q₀x⁸ Equation (3)

In Equation (3), the coefficient of the quadratic term of the polynomial R (x) (p₄q₄+p₃q₃+p₂q₂+p₁q₁+p₀q₀) is equivalent to the dot product result of the vector v and the vector u. In other words, after the computing accelerator 120 receives the ciphertext polynomials of the polynomial P (x) and the polynomial Q (x) after homomorphic encryption, it only needs to mutiply the two ciphertext polynomials and extract the coefficient of the quadratic term thereof so as to obtain the dot product result of the vector v and the vector u, and it is not necessary to decompose the components of each of the vector v and vector u from the ciphertext polynomials and then perform the corresponding multiplication calculations; therefore, the calculation complexity of the computing accelerator 120 can be effectively reduced.

In the present embodiment, the encoding unit 112 can encode the values in the plaintext data D1 into coefficients of the plaintext input polynomials PP1 to PPX in an appropriate order according to the type of the linear computation to be performed, such as, but not limited to, vector dot product, matrix multiplication, and convolution, so that the computing accelerator 120, after receiveing the ciphertexts of the plaintext input polynomials PP1 to PPX (i.e., the input polynomials IP1 to IPX), can perform polynomial multiplication on the input polynomials IP1 to IPX2, and obtain the desired computational result from the multiplied polynomial coefficients quickly, thereby reducing the computational effort of the computing accelerator 120.

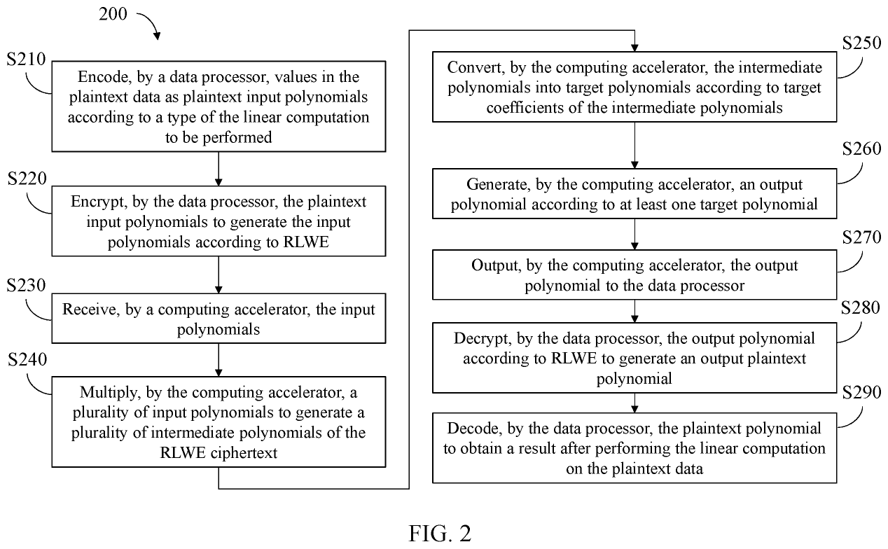

FIG. 2 is a flowchart of a calculation method 200 of homomorphic encryption according to one embodiment of the present disclosure. The calculation method 200 can be performed by the homomorphic encryption calculation system 100 and include Step S210 to S290.

In Step S210, the encoding unit 112 of the data processor 110 of can encode a plutality of values in the plaintext data D1 into plaintext input polynomials PP1 to PPX according to the type of linear computation. For example, the encoding unit 112 can encode the aforementioned vector u and vector v into polynomial P (x) and Q (x) as the plaintext input polynomials PP1 and PP2. However, the present disclosure is not limited thereto, in some other embodiments, the homomorphic encryption calculation system 100 may impose a specific requirement for the amount of terms of the plaintext input polynomials PP1 and PP2, such as, but not limited to, 1024 terms; in such case, the encoding unit 112 may encode the values in the plaintext data correspondingly. Further, the plaintext data D1 may correspond to a plurality of matrices in the matrix multiplication or correspond to an input image and a convolutional kernel of the convolutional computation; in these cases, the encoding unit 112 may encode the values of the plaintext data D1 according to the type of calculation to be performed for generating the plaintext input polynomials PP1 and PP2.

After the encoding unit 112 completes encoding, in Step S220, the encryption unit 114 in the data processor 110 may encrypt plaintext input polynomials PP1 to PPX according to RLWE to generate the input polynomials IP1 to IPX. Next, in Step S230, the computing accelerator 120 can receive the input polynomials IP1 to IPX generated by the data processor 110, and in Step S240 to Step S260, it may perform computations on the input polynomials IP1 to IPX to generate an output polynomial OP1 corresponding to the calculation result.

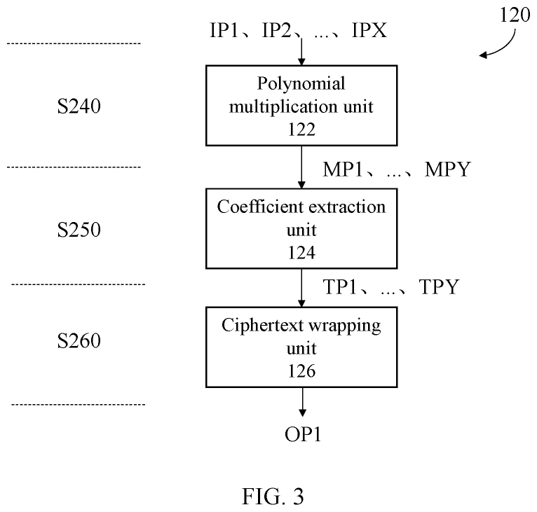

FIG. 3 is a schematic diagram illustrating the computing accelerator 120 according to one embodiment of the present disclosure. As shown in FIG. 3, the computing accelerator 120 can include a polynomial multiplication unit 122, a coefficient extraction unit 124 and a ciphertext wrapping unit 126. In Step S240, the polynomial multiplication unit 122 in the computing accelerator 120 can perform the multiplication calculation on the input polynomials IP1 to IPX to generate intermediate polynomials MP1 to MPY, wherein Y is an integer greater than 1. For example, the polynomial multiplication unit 122 may multiply the input polynomial IP1 with the input polynomial IP2 to obtain the intermediate polynomial MP1. Since the polynomial multiplication is a linear computation, the intermediate polynomial MP1 will remain to be the ciphertext of RLWE.

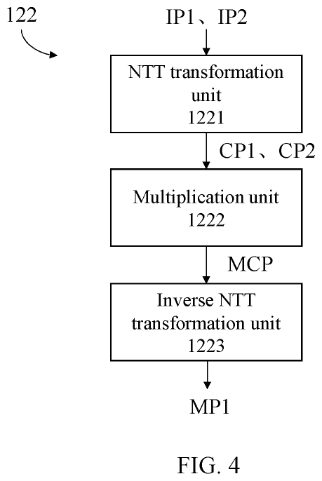

Further, since the polynomial multiplication is rather complex, in the present embodiment, the polynomial multiplication unit 122 may adopt the number-theoretic transformation (NTT) to simplify the calculation of the polynomial multiplication. FIG. 4 is a schematic diagram illustrating the polynomial multiplication unit 122 according to one embodiment of the present disclosure. As shown in FIG. 4, the polynomial multiplication unit 122 can include a number-theoretic transformation unit 1221, a multiplication unit 1222 and an inverse number-theoretic transformation unit 1223.

In the present embodiment, the number-theoretic transformation unit 1221 can perform number-theoretic transformation or fast fourier transformation (FFT) on the input polynomials IP1 and IP2; in such case, the multiplication unit 1222 only needs to multiply each coefficient in the transformed polynomial CP1 with a corresponding coefficient in the transformed polynomial CP2 so as to generate the intermediate transformed polynomial MCP. In other words, in the case where the number of terms of each of the input polynomials IP1 and IP2 is N, wherein N is an integer greater than 1, the multiplication of the transformed polynomials CP1 and CP2 requires only (N+1) operations of coefficient multiplication. In contrast, without the transformation of NTT or FFT, the multiplication of the input polynomials IP1 and IP2 would require (N+1) 2 operations of coefficient multiplication. Therefore, by performing NTT or FFT, the complexity of polynomial multiplication can be reduced. After multiplying the transformed polynomials CP1 and CP2 to generate the intermediate transform polynomial MCP, the inverse number-theoretic transformation unit 1223 can perform an inverse number theoretic transformation or inverse fast Fourier transformation on the intermediate transformed polynomial MCP to generate the intermediate polynomial MP1.

In the present embodiment, the input polynomial IP1 can correspond to a plurality of first plaintext values in the plaintext data D1, for example, but not limited to, the component values p₀, p₁, p₂, p₃ and p₄ of the vector v, and the input polynomial IP2 can correspond to a plurality of second plaintext values in the plaintext data D1, for example, but not limited to, the component values q₀, q₁, q₂, q₃ and q₄ of the vector u. In such case, the input polynomial IP1 and the input polynomial IP2 are equivalent to the RLWE ciphertexts of the polynomials P (x) and Q (x) of Equation (1) and Equation (2), whereas as shown in Equation (3), the coefficient of each term of the intermediate polynomial MP1 will be related to each dot product result of the first plaintext values p₀, p₁, p₂, p₃ and p 4 and second plaintext values q₀, q₁, q₂, q₃ and q₄.

In the present embodiment, if the linear computation that the homomorphic encryption calculation system 100 intends to perform on the plaintext data D1 is the dot product of the vector v and the vector u, then the coefficient of the quadratic term of the intermediate polynomial MP1 will correspond to the result of dot product calculatation of the first plaintext values p₀, p₁, p₂, p₃ and p₄ and second plaintext values q₀, q₁, q₂, q₃ and q₄. Thus, in Step S250, the coefficient extraction unit 124 can take the coefficient of the quadratic term of the intermediate polynomial MP1 as its target coefficient, and convert the intermediate polynomial MP1 of RLWE ciphertext into ciphertext encrypted with learning with errors (LWE), i.e., the target polynomial TP1, according to the target coefficient.

However, the present disclosure is not limited to performing vector dot product computation on the plaintext data; in some embodiments, the purpose of the user terminal may be performing a linear computation other than the vector dot product computation on the plaintext data D1. For example, the plaintext data D1 can include an input image and a convolutional kernel, and the purpose of the user terminal is to obtain a feature image after performing convolutional computation on the input image and the convolutional kernel. In such case, in Step S210, the data processor 110 may, for example, encode a plurality of plaintext values corresponding to at least a portion of the input image in the plaintext data D1 into the plaintext input polynomial PP1, and encode a plurality of second plaintext values corresponding to the convolutional kernel in the plaintext data D1 into the plaintext input polynomial PP2. In this way, after the data processor 110 performs the appropriate encoding, the computing accelerator 120 may generate the intermediate polynomial MP1 by multiplying the input polynomials IP1 and IP2 and obtain the target coefficient corresponding to at least a portion of the feature image from coefficients of a plurality terms of the intermediate polynomial MP1.

In addition, in some other embodiments, the plaintext data D1 may include a first matrix and a second matrix, and the purpose of the user terminal is to obtain a third matrix by multiplying the two matrices. In such case, in Step S210, the data processor 110 may, for example, encode a plurality of elements of the first column in the first matrix into the plaintext input polynomial PP1 and encode a plurality of elements of the first row in the second matrix into the plaintext input polynomial PP2. In such case, the target coefficient of the intermediate polynomial MP1 may, for example, correspond to the matrix element at the first column and the first row in the third matrix.

In some embodiments, to ensure that in Step S250, the computing accelerator 120 can extract the corresponding target coefficient, the data processor 110 may determine the encoding means for the plaintext data D1 according to the type of the linear computation to be performed, and may transmit a message to the computing accelerator 120 to inform the computing accelerator 120 the encoding means that should be adopted or the number of terms that corresponds to the target coefficient.

Furthermore, based on the contents of the plaintext data D1 and the needs of the linear computation to be performed, the data processor 110 may generate more than two input polynomials IP1 to IPX in Step S210 to Step S220, so that in Step S240, the computing accelerator 120 may also perform multiple rounds of polynomial multiplications on the input polynomials IP1 to IPX, and generate a plurality of intermediate polynomials MP1 to MPY correspondingly. Taking the aforementioned convolution computation and matrix multiplication as an example, the intermediate polynomials MP1 to MPY may each correspond, for example, to parts of the output feature image or to one of the elements in the third matrix, respectively, so that after the coefficient extraction unit 124 converts the intermediate polynomials MP1 to MPY into the target polynomials TP1 to TPY according to the target coefficients of the intermediate polynomials MP1 to MPY, the ciphertext wrapping unit 126 of the computing accelerator 120 may further, in Step S260, wrap the target polynomials TP1 to TPY into an output polynomials OP1 of the RLWE ciphertext. Consequently, the data processor 110 can obtain a more complete calculation result according to the output polynomial OP1, such as the full feature image or all elements in the third matrix.

It should be noted that in the method 200, the computing accelerator 120 may perform two rounds of conversions in ciphertext formats on the polynomials it computes; the first round is in Step S250, where the computing accelerator 120 performs the procedure of converting a RLWE ciphertext into a LWE ciphertext, and the second round is in Step S260, where the computing accelerator 120 performs the procedure of converting a plurality of LWE ciphertexts into a RLWE ciphertext. In the present embodiment, these two conversions in the ciphertext format may be done according to the principles of RLWE and LWE as well as each known conversion method.

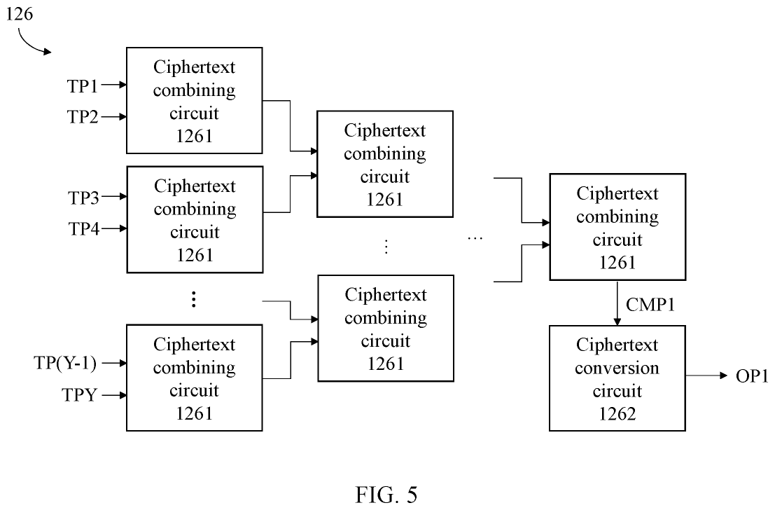

For example, Step S260 may be performed in two parts, wherein in the first part, a plurality of LWE ciphertexts are combined, and in second part, the combined ciphertext is converted. FIG. 5 is a schematic diagram illustrating the ciphertext wrapping unit 126 according to one embodiment of the present disclosure. The ciphertext wrapping unit 126 includes a plurality of ciphertext combining circuits 1261 and a ciphertext conversion circuit 1262.

The ciphertext combining circuit 1261 can combine the target polynomials TP1 to TPY into a combined polynomial CMP1. As shown in FIG. 5, each ciphertext combining circuit 1261 can combine two target polynomials or combine the combined polynomials outputted by two ciphertext combining circuits 1261, until all the target polynomials TP1 to TPY are combined into the combined polynomial CMP1. In other words, if Y is 2K, wherein K is a positive integer, then the ciphertext wrapping unit 126 can include (2^{K}−1) ciphertext combining circuits 1261. Consequently, the (2^{K}−1) ciphertext combining circuits 1261 can operate as a pipeline to perform the polynomial combination operations. Since the combined polynomial CMP1 generated by the ciphertext combining circuit 1261 is still a ciphertext encrypted with LWE, the ciphertext conversion circuit 1262 can then convert the combined polynomial CMP1 into the output polynomial OP1 according to RLWE encryption. However, the present disclosure is not limited to combining target polynomials TP1 to TPY by a pipeline scheme, and in some other embodiments, the designer may arrange an appropriate number of ciphertext combining circuits 1261 depending on its needs. For example, the ciphertext wrapping unit 126 may include only one single ciphertext combining circuit 1261, and can, after combining two polynomials, reuse its outputted polynomial as an input polynomial of the ciphertext combining circuit 1261 for combining with a further polynomial. By repeating the operation, it is possible to combine the intermediate polynomials MP1 to MPY into the combined polynomial CMP1 by using less hardware.

After the computing accelerator 120 generates the output polynomial OP1 according to the target polynomials TP1 to TPY, in Step S270, the computing accelerator 120 can output the output polynomial OP1 to the data processor 110.

As shown in FIG. 1, the data processor 110 may further include a decryption unit 116 and a decoding unit 118. The decryption unit 116 can receive the output polynomial OP1 returned from the computing accelerator 120, and in Step S280, it can decrypt the output polynomial OP1 according to RLWE to generate the output plaintext polynomial OPP1. Next, in Step S290, the decoding unit 118 can decode the plaintext polynomial OPP1 according to the type of linear computation to obtain the result R1 after performing linear computation on the plaintext data D1.

In summary, since the data processors, computing accelerators and calculation methods for homomorphic encryption provided in the embodiments of the present application can encode values in the plaintext data into polynomials based on the type of the linear computation to be performed, so after performing homomorphic encryption on the polynomials, the computing accelerator only needs to multiply the corresponding polynomials to generate the intermediate polynomials for obtaining the ciphertext corresponding to the calculation results of the plaintext data from coefficients of specific terms of the intermediate polynomials. As a result, the computational complexity required for the computing accelerator can be reduced, thereby achieving the efficacy of accelerated computation. Further, because the computing accelerator can convert the intermediate polynomial into a target polynomial according to the coefficients of the specific terms of a plurality of intermediate polynomials, and then wrap a plurality of target polynomials into one output polynomial, the transmission between the data processor and the computing accelerator can be more efficient.

The foregoing description briefly sets forth the features of some embodiments of the present application so that persons having ordinary skill in the art more fully understand the various aspects of the disclosure of the present application. It may be apparent to those having ordinary skill in the art that they can easily use the disclosure of the present application as a basis for designing or modifying other processes and structures to achieve the same purposes and/or benefits as the embodiments herein. It should be understood by those having ordinary skill in the art that these equivalent implementations still fall within the spirit and scope of the disclosure of the present application and that they may be subject to various variations, substitutions, and alterations without departing from the spirit and scope of the present disclosure.

What is claimed is:

1. A computing accelerator, configured to perform computations on a plurality of input polynomials of homomorphic encryption to generate output polynomials, wherein the plurality of input polynomials are ciphertexts generated from a plaintext data after ring learning with error (RLWE) encryption, and the output polynomials correspond to results after performing a linear computation on the plaintext data, and the computing accelerator comprises:
a polynomial multiplication unit, configured to multiply a first input polynomial and a second input polynomial in the plurality of input polynomials to generate a first intermediate polynomial, wherein the first input polynomial corresponds to a plurality of first plaintext values in the plaintext data, the second input polynomial corresponds to a plurality of second plaintext values in the plaintext data, and the first intermediate polynomial is a ciphertext encrypted using RLWE;
a coefficient extraction unit, configured to convert the first intermediate polynomial into a first target polynomial in a learning with errors (LWE) ciphertext according to a first target coefficient in a plurality of coefficients of the first intermediate polynomial, wherein the first target coefficient corresponds to a result of performing the linear computation on the plurality of first plaintext values and the plurality of second plaintext values; and
a ciphertext wrapping unit, configured to generate the output polynomial according to at least the first target polynomial, wherein the output polynomial is a ciphertext encrypted using RLWE.

2. The computing accelerator of claim 1, wherein the linear computation comprises a convolutional computation, the plurality of first plaintext values comprise at least a portion of an input image, the plurality of second plaintext values comprise a convolutional kernel, and the first target coefficient in the first intermediate polynomial corresponds to at least a portion of a feature image obtained after performing the convolutional computation on the convolutional kernel and the input image.

3. The computing accelerator of claim 1, wherein the linear computation comprises a vector dot product computation, the plurality of first plaintext values comprise a first vector, the plurality of second plaintext values comprise a second vector, and the first target coefficient of the first intermediate polynomial corresponds to a vector dot product of the first vector and the second vector.

4. The computing accelerator of claim 1, wherein the linear computation comprises a matrix multiplication computation, the plurality of first plaintext values comprise a plurality of first elements in a same column of a first matrix, the plurality of second plaintext values comprise a plurality of second elements in a same row of a second matrix, and the first target coefficient of the first intermediate polynomial corresponds to a matrix element obtained after multiplying the first matrix with the second matrix.

5. The computing accelerator of claim 1, wherein the polynomial multiplication unit comprises:
a number-theoretic transformation unit, configured to perform a number-theoretic transformation or a fast fourier transformation on the first input polynomial and the second input polynomial to generate a first transformed polynomial and second transformed polynomial;
a multiplication unit, configured to mutiply each coefficient of the first transformed polynomial with a corresponding coefficient of the second transformed polynomial to generate an intermediate transformed polynomial; and
an inverse number-theoretic transformation unit, configured to perform an inverse number-theoretic transform or an inverse fast fourier transformation on the intermediate transformed polynomial to generate the first intermediate polynomial.

6. The computing accelerator of claim 1, wherein:
the polynomial multiplication unit, further configured to multiply a third input polynomial with a fourth input polynomial in the plurality of input polynomials to generate a second intermediate polynomial, wherein the third input polynomial corresponds to a plurality of third plaintext values in the plaintext data, the fourth input polynomial corresponds to a plurality of fourth plaintext values in the plaintext data, and the second intermediate polynomial is a ciphertext encrypted using RLWE; and
the coefficient extraction unit, further configured to convert the second intermediate polynomial into a second target polynomial according to a second target coefficient in a plurality of coefficients of the second intermediate polynomial, wherein the second target coefficient corresponds to a result after performing the linear computation on the plurality of third plaintext values and the plurality of fourth plaintext values.

7. The computing accelerator of claim 6, wherein, the ciphertext wrapping unit comprises:
at least one ciphertext combining circuit, configured to combine at least the first intermediate polynomial and the second intermediate polynomial into a combined polynomial, wherein the combined polynomial is a ciphertext encrypted according to LWE; and
a ciphertext conversion circuit, configured to convert the combined polynomial into the output polynomial encrypted according to RLWE.

8. A data processor, configured to convert a plaintext data into a plurality of input polynomials of homomorphic encryption, and transmit the plurality of input polynomials to a remote computing accelerator so that the computing accelerator performs a linear computation required by the plaintext data, the data processor comprising:
an encoding unit, configured to encode a plurality of values in the plaintext data into a plurality of plaintext input polynomials according to a type of the linear computation; and
an encryption unit, configured to encrypt the plurality of plaintext input polynomials to generate the plurality of input polynomials according to ring learning with errors (RLWE).

9. The data processor of claim 8, wherein the encoding unit determines a first encoding order according to the type of the linear computation, and arrange a plurality of first values in the plaintext data as a plurality of coefficients of a plurality of terms of first plaintext input polynomial in the plurality of plaintext input polynomials according to the first encoding order.

10. The data processor of claim 9, wherein the encoding unit determines a second encoding order according to the type of the linear computation, and arranges a plurality of a second plaintext input polynomial as a plurality of coefficients of a plurality of terms of a second plaintext input polynomial in the plurality of plaintext input polynomials according to the second encoding order, wherein a total amound of the plurality of first values is equal to a total amound of the plurality of second values, and the first encoding order is different from the second encoding order.

11. The data processor of claim 8, further comprising:
a decryption unit, configured to receive an output polynomial returned from the computing accelerator and decryp the output polynomial according to RLWE to generate an output plaintext polynomial; and
a decoding unit, configured to perform decode the plaintext polynomial according to the type of the linear computation type to obtain a result after performing the linear computation on the plaintext data.

12. A method, for performing computations on a plurality of input polynomials of homomorphic encryption to achieve a linear computation of a plaintext data, the method comprising:
receiving, by a computing accelerator, the plurality of input polynomials, wherein the plurality of input polynomials are ciphertexts generated from a plaintext data after ring learning with error (RLWE) encryption;
multiplying, by the computing accelerator, a first input polynomial and a second input polynomial of the plurality of input polynomials to generate a first intermediate polynomial of the RLWE ciphertext, wherein the first input polynomial corresponds to a plurality of first plaintext values in the plaintext data, and the second input polynomial corresponds to a plurality of second plaintext values in the plaintext data;
converting, by the computing accelerator, the first intermediate polynomial into a first target polynomial according to a target coefficient in a plurality of coefficients of the first intermediate polynomial, wherein the first target coefficient corresponds to a result after performing the linear computation on the plurality of first plaintext values and the plurality of second plaintext values, and the first target polynomial is a ciphertext encrypted using learning with errors (LWE);
generating, by the computing accelerator, the output polynomial according to at least the first target polynomial, wherein the output polynomial is a ciphertext encrypted using RLWE; and
outputting, by the computing accelerator, the output polynomial to a data processor.

13. The method of claim 12, wherein the linear computation corresponds to a convolutional computation, the plurality of first plaintext values correspond to at least a portion of an input image, the plurality of second plaintext values correspond to a convolutional kernel, and the target coefficient of the first intermediate polynomial corresponds at least a portion of a feature image obtained after performing the convolutional computation on the convolutional kernel and the input image.

14. The method of claim 12, wherein the linear computation corresponds to a vector dot product computation, the plurality of first plaintext values correspond to a first vector, and the target coefficient of the first intermediate polynomial corresponds to a vector dot product of the first vector and the second vector.

15. The method of claim 12, wherein the linear computation corresponds to a matrix multiplication computation, the plurality of first plaintext values correspond to a plurality of first elements in the same column of a first matrix, the plurality of second plaintext values correspond to a plurality of second elements in the same row of a second matrix, and the first target of the first intermediate polynomial coefficient corresponds to a matrix element obtained after multiplying the first matrix with the second matrix.

16. The method of claim 12, wherein the step of multiplying, by the computing accelerator, the plurality the first input polynomial and the second input polynomial of input polynomials to generate the first intermediate polynomial comprises:
performing a number-theoretic transformation or a fast fourier transformation on the first input polynomial and the second input polynomial to generate a first transformed polynomial and a second transformed polynomial;
multiplying each coefficient of the first transformed polynomial and a corresponding coefficient of the second transformed polynomial to generate an intermediate transformed polynomial; and
performing an inverse number-theoretic transform or an inverse fast fourier transformation on the intermediate transformed polynomial to generate the first intermediate polynomial.

17. The method of claim 12, further comprising:
Encoding, by the data processor, a plutality of values in the plaintext data as a plurality of plaintext input polynomials according to a type of the linear computation to be performed;
encrypting, by the data processor, the plurality of plaintext input polynomials to generate the plurality of input polynomials according to RLWE; and
transmitting, by the data processor, the plurality of input polynomials to the computing accelerator.

18. The method of claim 12, further comprising:
decrypting, by the data processor, the output polynomial according to RLWE to generate an output plaintext polynomial; and
decoding, by the data processor, the plaintext polynomial to obtain a result after performing the linear computation on the plaintext data.
